(19) United States
(12) Patent Application Publication
(10) Pub. No.: US 2011/0248104 A1
(43) Pub. Date: Oct. 13, 2011

(54) MECHANIZED IRRIGATION SYSTEM WITH VARIABLE VALVE ASSEMBLY AND METHOD OF USE

(75) Inventor: Craig S. Malsam, Omaha, NE (US)

(73) Assignee: VALMONT INDUSTRIES, INC., Omaha, NE (US)

(21) Appl. No.: 13/083,218

(22) Filed: Apr. 8, 2011

Related U.S. Application Data
(60) Provisional application No. 61/321,999, filed on Apr. 8, 2010.

(51) Int. Cl. B05B 12/00

(52) U.S. Cl. 239/723

(57) ABSTRACT

The present disclosure is directed toward a mechanized irrigation system having a variable valve assembly and a corresponding method of use. The variable valve assembly generally includes a valve and an adjustment mechanism. The valve can be any type of valve known in the art that can be configured to variably control the flow rate of a fluid through a delivery conduit. Generally, the adjustment mechanism includes a motor or actuator that can vary the position of the valve through various methods known in the art. The variable valve assembly is generally located on the mechanized irrigation system to control the flow of an applicant that is dispersed by the irrigation system.

### CROSS-REFERENCE TO RELATED APPLICATIONS

The present application claims the benefit of 35 U.S.C. §119(e) of U.S. Provisional Application Ser. No. 61/321,999, filed Apr. 8, 2010, and titled Mechanized Irrigation System With Variable Valve Assembly and Method of Use. The above mentioned provisional application is incorporated herein by reference.

### BACKGROUND

Modern day agriculture has become increasingly efficient in the past century and this trend must continue in order to produce a sufficient food supply for the ever increasing world population. A notable advancement in agricultural production was the introduction of mechanized irrigation systems such as center pivot and linear move irrigators. These irrigation systems make it possible to irrigate entire fields thereby reducing a crop yield's vulnerability to extreme weather conditions. In more arid environments, mechanized irrigation systems are used to provide the amount of water and/or applicants to increase the available farmable acreage for an increased variety of crops and provide a profitable crop yield for that farmable acreage. In temperate environments, mechanized irrigation systems can be used to provide water to fields during extended periods without rain. The ability to monitor and control the amount of water applied to an agricultural field has increased the amount of farmable acres in the world and increases the likelihood of a profitable crop yield.

Many irrigation systems currently in use apply water and/or applicants to fields having up to 640 acres. This size of field inevitably has varying field and soil conditions that require different amounts of water and/or applicants applied at individual locations within the field. Some areas may be adjacent to a natural water source like a creek or stream. Some areas of the field may be low-lying and collect water, while still other locations in the field may include higher elevations and the water drains away from these locations. Many mechanized irrigation systems currently in use only allow for water to be applied at one constant flow rate throughout the entire rotation. This requires an operator to set the flow rate corresponding to the portion of the field that requires the most water to sustain crops. This is a very inefficient and wasteful method of irrigating because the areas of the field that do not require as much water will have more water applied than necessary. As water conservation efforts continue to advance in response to the increased demand for water in our world, providing the most efficient method of irrigating crops as possible will be required. Thus, a need exists in the art for a mechanized irrigation system that can precisely apply the minimum amount of water necessary at any given field location by varying the flow rate and the amount of an applicant applied over a defined area.

### SUMMARY

The present disclosure is generally directed toward a mechanized irrigation system having a variable valve assembly and a corresponding method of use. In an implementation, the mechanized irrigation system may be any mechanized irrigation system known in the art. The two most prevalent irrigation systems are center pivot irrigation systems and linear move irrigation systems. Mechanized irrigation systems generally include a water pipe section that spans between two or more support towers. The water pipe section generally includes at least a water pipe, which may also include other members, such as bottom chords and web members to comprise a trussed water pipe section. The mechanized irrigation systems may also include a control panel that monitors and controls the operation of the irrigation system.

The variable valve assembly of the present disclosure generally includes a valve and an adjustment mechanism. The valve can be any type of valve known in the art that can be configured to variably control the flow rate of a fluid through a delivery conduit. Generally, the adjustment mechanism includes a motor or actuator that can vary the position of the valve through various methods known in the art. An implementation of the variable valve assembly of the present disclosure includes a microprocessor. Another implementation of the variable valve assembly includes an internal memory. The variable valve assembly is generally in electronic communication with the control panel or other controller wherein the electronic communication may be achieved through any wired or wireless connection, or any other electronic communication method known in the art.

The variable valve assembly is generally located on the mechanized irrigation system to control the flow of an applicant that is dispersed by the irrigation system. Applicants include, but are not limited to: water, herbicide, pesticide, fertilizer, any known substance currently dispersed through mechanized irrigation systems, or combinations thereof. An implementation of the present disclosure includes the variable valve assembly coupled directly to the water pipe. Another implementation of the present disclosure includes the variable valve assembly located along a delivery conduit wherein the delivery conduit includes a U-pipe and a drop hose, and supplies the applicant to a sprinkler head. Yet another implementation includes the variable valve assembly included in a coupler that couples the drop hose to the U-pipe.

Generally, an operator will generate a water application map for a given field to be irrigated. The water application map sets forth a pre-determined flow rate of water or an applicant over an identified area of the field. The water application map may be preprogrammed into at least one variable valve assembly. The water application map may also be pre-programmed into the control panel. The location of the irrigation system within the field is determined using any method known in the art and a control panel, or other controller, mounted on the mechanized irrigation system communicates the irrigation system's actual field position to each variable valve assembly. The control panel may also receive the irrigation system's actual field position and communicate the pre-determined flow rate required directly to the variable valve assembly. The variable valve assembly then adjusts the flow of the applicant such that the pre-determined flow rate corresponding to the actual position of the irrigation system in the field is provided. An implementation of the variable valve assembly may also include a monitoring mechanism that sends an error message to the control panel if the valve position is not in its pre-determined position, or is not providing the pre-determined flow rate corresponding to the irrigation system's current position.

### DRAWINGS

The accompanying drawing forms a part of the specification and is to be read in conjunction therewith, in which like reference numerals are employed to indicate like or similar parts in the various views, and wherein:

FIG. 1 is a top perspective diagrammatic view of a mechanized irrigation system in accordance with an implementation of the present disclosure;

FIG. 2 is a front diagrammatic view of a U-pipe and drop hose coupler in accordance with an implementation of the present disclosure;

FIG. 3A is a cross-sectional diagrammatic view illustrating a variable valve assembly in accordance with a possible implementation of the present disclosure, wherein the variable valve assembly comprises a rack and pinion assembly;

FIG. 3B is a bottom diagrammatic view illustrating the variable valve assembly shown in FIG. 3A;

FIG. 4A is a cross-sectional diagrammatic view illustrating a variable valve assembly in accordance with another possible implementation of the present disclosure, wherein the variable valve assembly comprises a gear worm assembly; and

FIG. 5 is a flow diagram illustrating an example processor for operating the mechanized irrigation system shown in FIG. 1

### DETAILED DESCRIPTION

The following detailed description references the accompanying drawing figures that illustrate specific implementations in which the disclosure can be practiced. The implementations are intended to describe aspects of the disclosure in sufficient detail to enable those skilled in the art to practice the disclosure. Other implementations can be utilized and changes can be made without departing from the scope of the present disclosure. The present disclosure is defined by the appended claims and the description is, therefore, not to be taken in a limiting sense and shall not limit the scope of equivalents to which such claims are entitled.

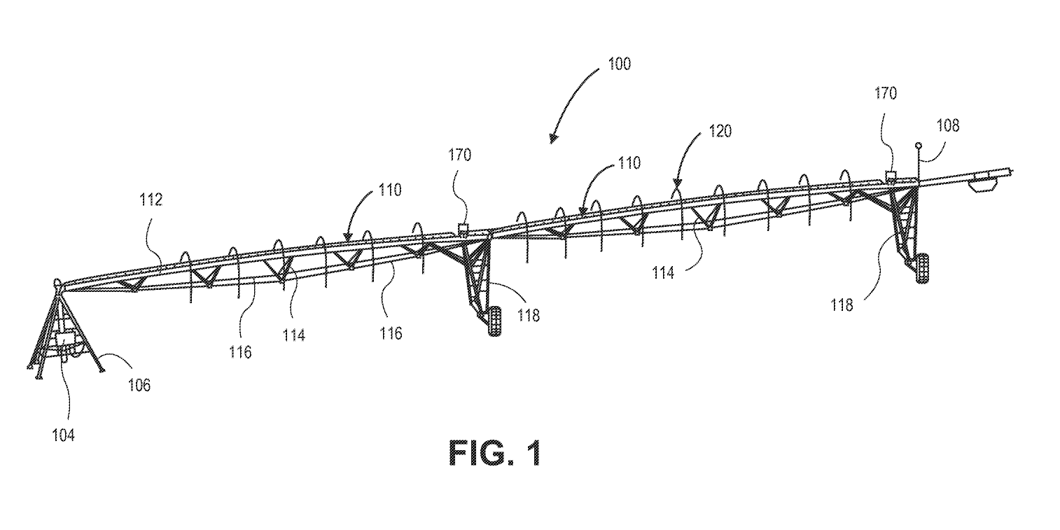

As illustrated in FIGS. 1 through 4B, the present disclosure is directed to a mechanized irrigation system 100 having at least one variable valve assembly 102 configured to variably control the flow rate of an applicant dispersed by the mechanized irrigation system 100. The mechanized irrigation system 100 of the present disclosure may be any type of irrigation system known in the art. For example, the two prevalent irrigation system types include the center pivot irrigation system and the linear move irrigation system. Center pivot irrigation systems generally have a main pivot and at least one water pipe section supported by one or more towers wherein the water pipe section rotates in a radial direction around the main pivot. Center pivot irrigation systems introduce water into the irrigation system through piping located at the main pivot and often draw the water from a well located underneath the main pivot or in close proximity to the field. The main pivot can be fixed or can be towable such that an operator can move the mechanized irrigation system from one field to another.

Linear move irrigation systems are often used in longer, more rectangular fields. Linear move irrigation systems generally include at least one water pipe section that spans a desired length across the short dimension of the field and is supported by at least one tower. Linear move irrigation systems generally travel linearly along the long direction of a field. Water is generally supplied to linear move irrigation systems through a hose pulled by the irrigation system, or through an irrigation ditch containing water that runs along the outside of the field's longer dimension. In addition to the center pivot and linear move irrigation systems described above, other implementations of irrigation systems are well known in the art and within the scope of the present disclosure.

In an implementation of the present disclosure, as illustrated in FIG. 1, the mechanized irrigation system 100 includes a control panel 104 generally mounted to the main pivot 106, a control cart, or a tower. The control panel 104 is generally located on the structural element 106 of the mechanized irrigation system 100 where the water is introduced into the irrigation system 100, but any other configuration known in the art is within the scope of the present disclosure. The control panel 104 generally can monitor many operating conditions as well as control many functions of the mechanized irrigation system 100. In certain implementations, the control panel 104 may actively monitor the mechanized irrigation system's 100 function and performance including, but not limited to: the GPS location of the pipe section or the towers (via one or more position sensors 108, such as a global positioning system receiver (GPS) receiver, positioned on the mechanized irrigation system 100); whether the mechanized irrigation system 100 is on or off; a voltage associated with the mechanized irrigation system 100; a motor speed of the mechanized irrigation system 100; an actual ground speed of the mechanized irrigation system 100; a direction the mechanized irrigation system 100 is traveling; a safety status of the mechanized irrigation system 100; diagnostics associated with the mechanized irrigation system 100; an applicant status (e.g., is water flowing through the mechanized irrigation system 100); whether the Stop in Slot (SIS) is on or off; a water pressure associated with the mechanized irrigation system 100; a time; a date; a field position of the irrigation system components, an end-gun status; and whether the programs (e.g., computer executable code) are running properly. The control panel 104 also controls the mechanized irrigation system's 100 functions and settings, including, but not limited to: starting and stopping of the mechanized irrigation system 100, turning the water on and off, the water application depth, the direction of travel, turning SIS on and off, automatically reversing or stopping the mechanized irrigation system 100, automatically restarting the mechanized irrigation system 100, allowing auxiliary control of the mechanized irrigation system 100, allowing for the writing and the editing of one or more irrigation programs (e.g., computer executable code), and controlling the sector and the sequential programs. Implementations of the present disclosure may also include the control panel 104 causing an alert (e.g., a visual alert, an audio alert) to a user if there are any errors in the operation of the mechanized irrigation system 100 or if any of the functions or conditions the control panel is monitoring have ceased or are outside an acceptable range.

Generally, the control panel 104 is housed in a weather-proof box and includes at least an internal memory (not shown), a microprocessor (not shown), and a user-interface (not shown). The control panel 104 is generally operated using proprietary software (e.g., computer executable programs) and may be connected to a network that allows a user to remotely input operational parameters, remotely view the operational status of the mechanized irrigation system 100, and receive remote alerts if the mechanized irrigation system 100 is not operating correctly. The control panel is generally in electronic communication with the various sensors, switches, motors, valves, pumps, and monitors that control the operation of the mechanized irrigation system 100 and allow the control panel 104 to monitor the operating conditions of the mechanized irrigation system 100. This electronic communication may be achieved through a wired or a wireless connection, or any other electronic communication method known in the art. A person of skill in the art will recognize that many implementations of the control panel 104 are known in the art and all such implementations of the control panel are within the scope of the present disclosure.

An implementation of the water pipe section 110 is a truss spanning between two towers 118, wherein the water pipe section 110 has a triangular cross-section and includes the water pipe 112 as the top chord, a plurality of truss webs 114, and two bottom chords 116. Implementations of the water pipe section 110 may also be comprised solely of the water pipe 112. The water pipe section 100 generally will span between at least two towers 118; however, implementations of the present disclosure may also be supported by one tower 118.

The water pipe section 110 may be configured to span any length. The span length of the water pipe section 110 generally depends on the design of the water pipe section 110 to support the weight of water contained in the water pipe 112 when full, the weight of materials of the water pipe section 110, and any forces applied to the water pipe section 110 when traveling over an agricultural field. A common range of span length of the water pipe section 110 is about 50 feet to about 225 feet. The design process of the water pipe section 110 is well known in the art, and may result in many cross-sections of the water pipe section 110, and/or combinations of sizes and configurations of the water pipe 112, truss webs 114, and bottom chords 116. The present disclosure is not intended to be limited to a particular water pipe section design and a person of skill in the art will recognize that any water pipe section design known in the art, sufficient to span between supports (e.g., towers 118), is within the scope of the present disclosure. In implementations of the present disclosure including more than one water pipe section 110, the water pipe sections 110 may be operably connected to each other through a water-tight, flexible connection. Such water pipe section 110 connections are well known in the art and all known connection configurations are within the scope of the present disclosure.

The water pipe section 110 and its components may be constructed from any structural shape known in the art. The water pipe 112 is generally a thin-walled pipe having any diameter wherein the more common diameters in the art include: five inches (5″), six inches (6″), six and five-eights inches (6⅝″), eight and five-eights inches (8⅝″), and ten inches (10″). Truss webs 114 and bottom chords 116 may be any structural shape known in the art, including: angles, channels, tubes, pipes, wide flange, “T” shapes, tensioned cables, solid sections, or any other known shape in the art or combination thereof and including any tab or gusset plates as required. The water pipe section 110 and its components as identified above may be made of any material known in the art including, aluminum, polyethylene, PVC, other plastic compositions, galvanized steel, stainless steel, or combinations thereof.

Throughout the mechanized irrigation system 100, components may be coupled using any coupling method known in the art, including, but not limited to: bolts, screws, rivets, welds, clamps, threaded connections, pins, sleeves, or any other connection method known in the art and any combination thereof.

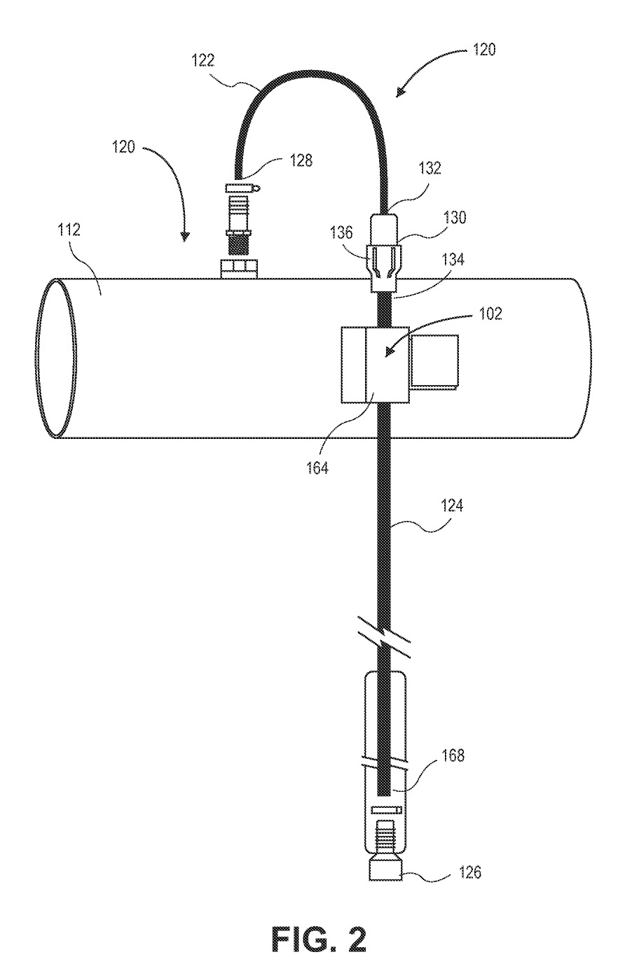

As illustrated in FIG. 1, the water pipe section 110 includes a plurality of delivery conduits 120 generally extending downward from the water pipe 112. An implementation of the delivery conduit 120, as shown in FIG. 2, includes an U-pipe 122 and a drop hose 124. The delivery conduit 120 is generally operably connected (e.g., male/female thread connectors, etc.) to a sprinkler head 126. An implementation of the mechanized irrigation system 100 may include any U-pipe 122 configuration known in the art where a first end 128 of the U-pipe 122 is removably coupled (e.g., male/female thread connectors, etc.) to the water pipe 112. An implementation of the U-pipe 122 includes a pressure regulator 130 proximate to a second end 132 of the U-pipe 122. The U-pipe 122 may be in any configuration and made from any material known in the art. The drop hose(s) 124 may be any flexible or rigid tubing of any size and material as known in the art. One implementation includes a first end 134 of the drop hose 124 removably coupled to the second end 132 of the U-pipe 122. An implementation also includes the drop hose 124 removably coupled to the U-pipe 122 by a coupler 136. An implementation may also include the coupler 136 including a variable valve assembly 102. Another implementation of the present disclosure includes the variable valve assembly 102 proximate to the first end 134 of the drop hose 124 (e.g., proximate to the second end 132 of the U-pipe 122). In other implementations, the variable valve assembly 102 may be located at any position along the length of the delivery conduit 120. In yet a further implementation, the variable valve assembly 102 may be directly mounted to the water pipe 112 and configured to receive the delivery conduit 120 or provide variable flow of the applicant from the water pipe 112 itself.

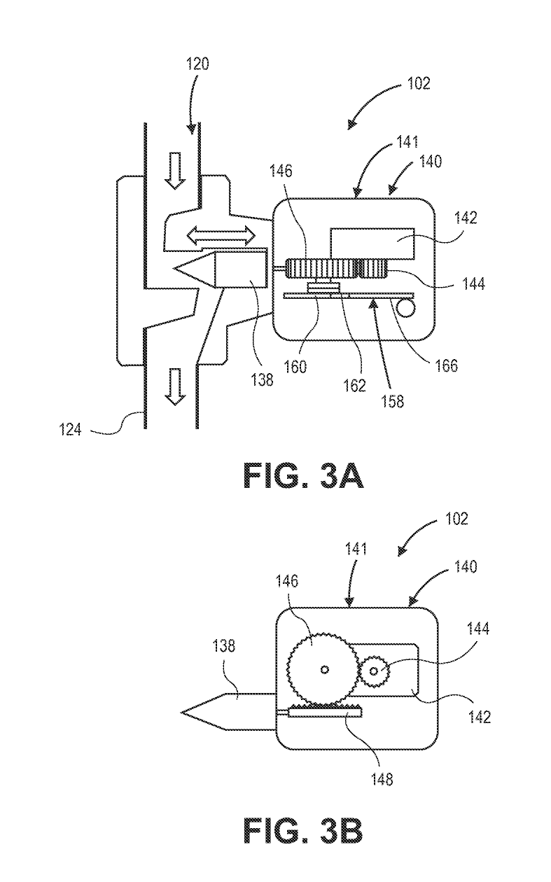

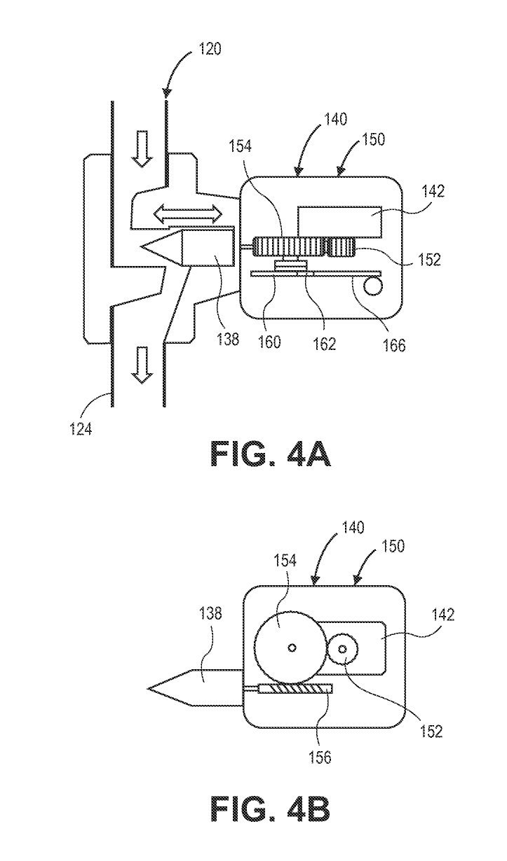

The variable valve assembly 102 generally furnishes variable control of the flow rate of the applicant (e.g., water, or the like) that is dispersed from the sprinkler head 126. As illustrated in FIGS. 3A through 4B, the variable valve assembly 102 includes a valve 138 and an adjustment mechanism 140. The valve 138 may be any suitable valve type known in the art that can incrementally control the amount of applicant that flows through the delivery conduit 120. As illustrated in FIGS. 3A through 4B, the valve 138 is comprised of a needle valve. The valve 138 generally permits a flow rate in a range from about zero to about one-hundred percent (0-100%) through the delivery conduit 120. The valve 138 is configured to control the flow of fluid (e.g., applicant, water, etc.) by reducing the cross-sectional area that the fluid can flow through. In an implementation, an operator may vary the flow through the delivery conduit 120 at one-percent (1%) intervals. However, more precise and less precise intervals are also contemplated. For example, the operator may vary the flow through the delivery conduit 120 at point five percent (0.5%) intervals. In another example, the operator may vary the flow through the delivery conduit 120 at five percent (5%) intervals.

The valve 138 can be adjusted for variable flow rates using the adjustment mechanism 140. Implementations of the adjustment mechanism 140 may include an electric motor, a gearing assembly, a servo actuator, or a linear actuator to adjust the position of the valve to vary the flow rate of the applicant through the delivery conduit. It will be recognized by persons of skill in the art that there are multiple controls, motors, and mechanisms that can be used to control the amount of the applicant flowing through the delivery conduit 120 via the valve 138 that are within the scope of the present disclosure. In an implementation, as illustrated in FIGS. 3A and 3B, the adjustment mechanism 140 is comprised of a rack and pinion gear assembly 141. The rack and pinion gear assembly 141 includes an electric motor 142 that generally rotates a drive gear 144 engaged with a pinion gear 146 that further engages a rack 148 causing linear translation of the valve 138. In another implementation, as illustrated in FIGS. 4A and 4B, the valve 138 includes the electric motor 142 to rotate a worm gear assembly 150 configured to provide linear translation to the valve 138. For example, the worm gear assembly 150 includes the electric motor 142 that generally rotates a drive gear 152 engaged with a worm gear 154 that further engages a shaft 156. In yet another implementation, the adjustment mechanism 140 can vary the flow rate by varying the linear position of the needle (e.g., valve 138) in a needle valve. A valve 138 incorporating a rotational adjustment as known in the art is within the scope of the present disclosure; therefore, other variable valve assemblies 102 utilizing a motor and a corresponding mechanism to effectuate a rotational adjustment of the valve as known in the art are also within the scope of the present disclosure. The motor, servo actuator, or linear actuator can be any type known in the art that is suitable for being used in the present disclosure. The electricity supply cables (not shown) are generally installed along the mechanized irrigation system 100 equipment to provide power to the variable valve assembly 102. An implementation of the present disclosure includes a low-voltage motor (not shown) that does not exceed plus thirty volts alternating current (+30 VAC) or plus thirty volts direct current (+30VDC) to avoid UL registration requirements.

An implementation of the variable valve assembly 102 may also include a circuit board 158 that includes a microprocessor 160 and/or an internal memory device 162 in electronic communication with the motor (e.g., electric motor 142) of the variable valve assembly 102. For example, the microprocessor 160 may be configured to transmit a signal to the adjustment mechanism 102 (e.g., electric motor 142) such that the adjustment mechanism 102 adjusts the position of the valve 138 to set the flow rate through the delivery conduit 120. The microprocessor 160 may also be configured to control the flow of electricity to the adjustment mechanism 140 thereby acting as a switch to turn the adjustment mechanism 140 on and off to effectuate the valve 138 adjustment. The variable valve assembly 102 may also include a feedback potentiometer (not shown), or other mechanism, configured to measure the position of the valve 138 or flow rate through the valve 138. If the variable valve assembly 102 is unable to position the valve 138 in the commanded position or provide the desired flow rate, then the variable valve assembly 102 reports an error message via the microprocessor 160 to the control panel 104. An implementation of the present disclosure includes the motor (e.g., motor 142), adjustment mechanism 140, microprocessor 160, and memory 162 being contained within a housing 164 (see FIG. 2). In an implementation, the housing 164 may be water-resistant and/or water-proof box.

The variable valve assembly 102 is in electronic communication with the control panel 104, or other controller known in the art, which may be achieved through a wired or a wireless connection, or any other electronic communication method known in the art. For example, the variable valve assembly 102 may include a receiver 166 (e.g., a Zigbee radio receiver, or the like) configured to receive signals transmitted from a transmitter (not shown) associated with the control panel 104, or a controller, to the variable valve assembly 102, or vice-versa. In one or more implementations, the receiver 166 may be included in the circuit board 158 of the variable valve assembly 102. The signal sent by the control panel 104, or the controller, may communicate any parameter to the variable valve assembly 102 pertinent to determining, or adjusting, the flow rate through the valve 138 of the variable valve assembly 102. One implementation communicates the current position of the mechanized irrigation system 100 in the field (e.g., via GPS signals, or the like). Another implementation includes directly communicating the percent of flow to the variable valve assembly 102. This communication is generally made at predetermined time intervals.

An implementation of the present disclosure may include a variable valve assembly 102 with all delivery conduits 120 of the mechanized irrigation system 100. In another implementation, the variable valve assembly 102 may be included only with certain individual delivery conduits 120 in combination with other delivery conduits 120 having no variable flow rate capability.

The drop hose 124 length may be of any length known in the art. In one implementation, the drop hose 124 length generally corresponds to the type of crop being irrigated. A sprinkler head 126 is operably connected to the second end 168 of the drop hose 124. Sprinkler heads 126 disperse the applicant over the crop of the agricultural field and the amount of the applicant dispersed, as well as the drop pattern, of each sprinkler head 126 corresponds to the flow rate through the delivery conduit 120. The flow rate delivered to the sprinkler head 126 can be variably adjusted using the variable valve assembly 102. There are multiple known sprinkler heads 126 and delivery conduit types, spacing and configurations known in the art. Factors considered in selecting a sprinkler head 126 and delivery conduit 120 include, but are not limited to: the crop being grown, the type of applicant (e.g., water, fertilizer, herbicide or pesticide), the type of soil, typical weather conditions, and the growing conditions. Sprinkler heads 126 and delivery conduits 120 can be manufactured from a number of materials, including: PVC, polyethylene, various other plastic formulations, aluminum, rubber, steel, and other metals. It is contemplated that other materials may be utilized to manufacture sprinkler heads 126 and delivery conduits 120. The present disclosure is intended to include all known sprinkler heads 126 and delivery conduit 120 types and configurations at any spacing known in the art.

The tower(s) 118 may be any tower configuration known in the art to adequately support the water pipe sections 110. The water pipe section 110 can be secured to a tower 118 through any method known in the art. Each tower 118 may generally have its own drive system (not shown) to propel the tower and irrigation system through the field. One implementation of the present disclosure includes the drive system in what is recognized in the art as a center-drive configuration. The present disclosure is not limited to a center-drive configuration, and any drive system configuration known in the art will be recognized to be within the scope of the present disclosure. An implementation of the present disclosure may also include a tower box 170 in electronic communication with one or more control panels 104, a position sensor 108, at least one variable valve assembly 102, or other controllers.

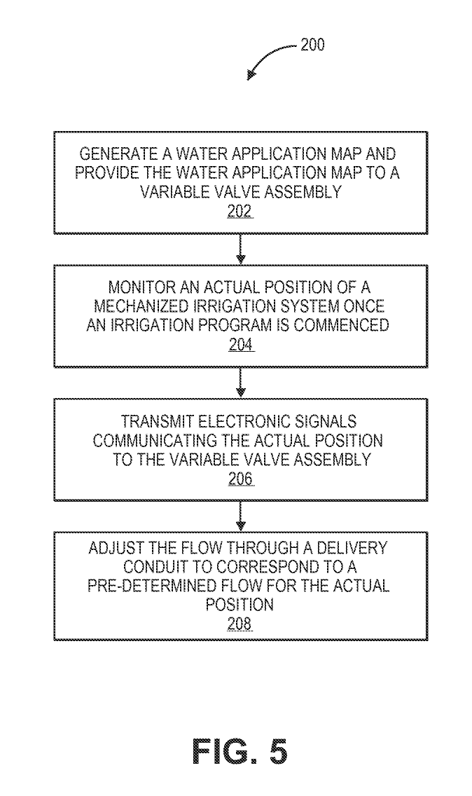

As illustrated in FIG. 5, an operator first generates a water application map via a computing device (Block 202). It is contemplated that the water application mapping program may be comprised of computer executable instructions (e.g., computer executable format), or the like. In one or more implementations, the computing device may include, but are not limited to: a personal computer, a laptop computer, a smartphone, and so forth. The water application map generally illustrates a desired water application in a particular field by dividing the field into zones and identifying the amount of the applicant to be applied to a given zone. The microprocessor of the variable valve assembly 102 is pre-programmed with information including, but not limited to: the location of the variable valve assembly along the mechanized irrigation system and the general water application map. An implementation of the present disclosure further includes the variable valve assembly 102 being pre-programmed with its own unique water application map. The unique water application map for each variable valve assembly 102 generally sets forth the pre-determined flow rate as a percentage of full flow that corresponds to a rotational position of the mechanized irrigation system 100 in the field. In another implementation, the field position may be based on a linear position or geographic coordinates instead of the rotational position. An example of a water application map for a variable valve assembly 102 setting forth the percent of full flow application corresponding to the mechanized irrigation system's rotational position in the field is presented in Table 1. In one or more implementations, the water application map may be structured as a lookup table, or the like.

TABLE 1

| Machine Position (Degrees) | Percent Application (%) |
|---|---|
| 0.0 | 10 |
| 0.1 | 69 |
| 0.2 | 23 |
| 0.3 | 11 |
| 0.4 | 0 |
| . | . |
| . | . |
| . | . |
| 359.9 | 37 |

The position of the irrigation system 100 is monitored once the mechanized irrigation system 100 commences an irrigation program (Block 204). In one or more implementations, the position of the mechanized irrigation system 100 can be determined using any method known in the art including, but not limited to: measuring the rotation about the center pivot using a rotational encoder, measuring GPS coordinates and then calculating the rotational translation, determining the Cartesian coordinates of each variable valve assembly 102 using ultrasonic positioning system (UPS) techniques, or any other position sensor known in the art. In one implementation, the control panel 104 receives the signals corresponding to the mechanized irrigation system's 100 position from the position sensor 108 and then calculates the mechanized irrigation system's 100 position using any known method in the art.

Next, the control panel 104 transmits one or more electronic signals to one or more variable valve assemblies 102 communicating the actual position of the mechanized irrigation system 100 (Block 206). In an implementation, the control panel 104 may transmit one or more signals via a transmitter to each individual variable valve assembly 102. In another implementation, the control panel 104 may transmit one or more signals to a subset of the variable valve assemblies 102 (e.g., send a signal to one or more variable valve assemblies 102 but not all of the variable valve assemblies 102). The field position of the irrigation system 100 is generally sent to the one or more variable valve assemblies 102 at a pre-determined time interval. Another implementation includes a GPS receiver (e.g., the position sensor 108) mounted on the mechanized irrigation system 100 where a controller (not shown) receives the GPS position and converts it into machine position or rotation angle according to known methods. The controller is in electronic communication with the variable valve assemblies 102 and transmits a signal that communicates the machine position to the variable valve assemblies 102. This implementation can be used if the mechanized irrigation system 100 does not include a control panel.

The variable valve assembly 102 then adjusts the flow through the delivery conduit 120 to correspond to the pre-determined flow for the actual position of the mechanized irrigation system 100 in the field (Block 208). In an implementation, the microprocessor 160 compares the actual position to the corresponding field position stored in the water application map to determine the applicable flow rate for the actual position of the mechanized irrigation system 100. Once the applicable flow rate is determined, the microprocessor 160 sends a signal communicating the flow rate to the adjustment mechanism 140 so that the adjustment mechanism 140 can adjust the valve to the proper position. In another implementation of the present disclosure, a feedback mechanism or potentiometer sends a signal corresponding to the operating position of the valve 138 to the microprocessor 160 and the microprocessor 160 compares the operating position of the valve 138 to the predetermined valve 138 position for the irrigation system's 100 current position. If the valve 138 is not in the commanded position, the microprocessor 160 sends a signal to the control panel 104 that furnishes an error message. A plurality of delivery conduits 120 having a variable valve assembly 102 varying the flow rate of applicant being applied to a field allows for a customized variable rate mechanized irrigation system to more efficiently apply water to a field having unique and varying watering requirements.

From the foregoing, it may be seen that the mechanized irrigation system 100 is particularly well suited for the proposed usages thereof. Furthermore, since certain changes may be made in the above disclosure without departing from the scope hereof, it is intended that all matter contained in the above description or shown in the accompanying drawing be interpreted as illustrative and not in a limiting sense. It is also to be understood that the following claims are to cover certain generic and specific features described herein.

What is claimed is:

1. A mechanized irrigation system comprising:
at least one water pipe section;
at least one delivery conduit removably coupled to the at least one water pipe section; and
at least one variable valve assembly coupled to the delivery conduit, the at least one variable valve assembly configured to variably control a flow rate of an applicant flowing through the at least one delivery conduit.

2. The mechanized irrigation system of claim 1, wherein the at least one delivery conduit comprises a U-pipe and a drop hose, the U-pipe coupled to the drop hose via a coupler.

3. The mechanized irrigation system of claim 2, wherein the coupler includes the variable valve assembly.

4. The mechanized irrigation system of claim 1, wherein the at least one variable valve assembly comprises a valve configured to control the flow rate of the applicant flowing through the at least one delivery conduit and an adjustment mechanism configured to adjust the valve.

5. The mechanized irrigation system of claim 4, wherein the adjustment mechanism comprises a rack and pinion gear assembly.

6. The mechanized irrigation system of claim 4, wherein the adjustment mechanism comprises a worm gear assembly.

7. The mechanized irrigation system of claim 4, wherein the at least one variable valve assembly further includes a circuit board with a microprocessor, the microprocessor configured to furnish a signal to the adjustment mechanism to adjust the valve to set the flow rate of the applicant flowing through the at least one delivery conduit.

8. A mechanized irrigation system comprising:
at least one water pipe section; and
at least one variable valve assembly having a first end and a second end, the at least one variable valve assembly coupled to the water pipe section at the first end, the at least one variable valve assembly configured to variably control a flow rate of an applicant flowing through the at least one variable valve assembly.

9. The mechanized irrigation system of claim 8, further comprising at least one delivery conduit removably coupled to the second end of the at least one variable valve assembly.

10. The mechanized irrigation system of claim 9, wherein the at least one delivery conduit comprises a U-pipe and a drop hose, the U-pipe coupled to the drop hose via a coupler.

11. The mechanized irrigation system of claim 8, wherein the at least one variable valve assembly comprises a valve configured to control the flow rate of the applicant flowing through the at least one variable valve assembly and an adjustment mechanism configured to adjust the valve.

12. The mechanized irrigation system of claim 11, wherein the adjustment mechanism comprises a rack and pinion gear assembly.

13. The mechanized irrigation system of claim 11, wherein the adjustment mechanism comprises a worm gear assembly.

14. The mechanized irrigation system of claim 11, further comprising a control panel configured to furnish at least one signal to the at least one variable valve assembly to adjust the flow rate of the adjustment mechanism.

15. The mechanized irrigation system of claim 11, wherein the adjustment mechanism adjusts the valve based upon a position of the mechanized irrigation system.

16. The mechanized irrigation system of claim 11, wherein the at least one variable valve assembly further includes a circuit board with a microprocessor, the microprocessor configured to furnish a signal to the adjustment mechanism to adjust the valve to set the flow rate of the applicant flowing through the at least one delivery conduit

17. A method comprising:
receiving a water application map in a computer executable format, the water application map including at least one pre-determined water flow rate corresponding to at least one pre-identified field position of a mechanized irrigation system;
receiving an actual field position of the mechanized irrigation system; and
adjusting a valve of the variable valve assembly via an adjustment mechanism to provide water at a pre-determined water flow rate furnished by the water application map corresponding to the actual field position.

18. The method of claim 18, wherein receiving an actual position further comprises receiving one or more signals communicating the actual field position from a control panel.

19. The method of claim 18, wherein the actual field position is compared to a corresponding pre-identified field position included in the water application map to determine the pre-determined water flow rate.

20. The method of claim 18, wherein the adjustment mechanism comprises a rack and pinion gear assembly.
